(19) United States
(12) Patent Application Publication
(10) Pub. No.: US 2004/0015581 A1
(43) Pub. Date: Jan. 22, 2004

(54) Dynamic deployment mechanism

(76) Inventor: Bryn B. Forbes, Santa Clara, CA (US)

Correspondence Address: KENYON & KENYON, 1500 K STREET, N.W., SUITE 700, WASHINGTON, DC, 20005, US

(21) Appl. No.: 10/199,006

(22) Filed: Jul. 22, 2002

(51) Int. Cl. G06F 15/173

(52) U.S. Cl. 709/224

(57) ABSTRACT

A deployment server is provided that includes a first mechanism to determine a status of a first server and a second mechanism to gather an image of a second server. A third mechanism may deploy the image of the second server to the first server based on the determined status.

### FIELD

The present invention relates to the field of computer systems. More particularly, the present invention relates to a dynamic deployment mechanism for hardware entities.

### BACKGROUND

As technology has progressed, the processing capabilities of computer systems have increased dramatically. This increase has led to a dramatic increase in the types of software applications that can be executed on a computer system as well as an increase in the functionality of these software applications.

Technological advancements have led the way for multiple computer systems, each executing software applications, to be easily connected together via a network. Computer networks often include a large number of computers, of differing types and capabilities, interconnected through various network routing systems, also of differing types and capabilities.

Conventional servers typically are self-contained units that include their own functionality such as disk drive systems, cooling systems, input/output (I/O) subsystems and power subsystems. In the past, multiple servers may be utilized where each server is housed within its own independent cabinet (or housing assembly). However, with the decreased size of servers, multiple servers may be provided within a smaller sized cabinet or be distributed over a large geographic area.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example arrangements and embodiments of the invention, it should be clearly understood that the same is by way of illustration and example only and that the invention is not limited thereto.

The following represents brief descriptions of the drawings in which like reference numerals represent like elements and wherein:

FIG. 1 is an example data network according to one arrangement;

FIG. 2 is an example server assembly according to one arrangement;

FIG. 3 is an example server assembly according to one arrangement;

FIG. 4 is an example server assembly according to one arrangement;

FIG. 5 is a topology of distributed server assemblies according to an example embodiment of the present invention;

FIG. 6 is a block diagram of a deployment server according to an example embodiment of the present invention; and

FIGS. 7A-7E show operations of a dynamic deployment mechanism according to an example embodiment of the present invention.

### DETAILED DESCRIPTION

In the following detailed description, like reference numerals and characters may be used to designate identical, corresponding or similar components in differing figure drawings. Further, in the detailed description to follow, example values may be given, although the present invention is not limited to the same. Arrangements and embodiments may be shown in block diagram form in order to avoid obscuring the invention, and also in view of the fact that specifics with respect to implementation of such block diagram arrangements and embodiments may be highly dependent upon the platform within which the present invention is to be implemented. That is, such specifics should be well within the purview of one skilled in the art. Where specific details are set forth in order to describe example embodiments of the invention, it should be apparent to one skilled in the art that the invention can be practiced without, or with variation of, these specific details. Finally, it should be apparent that differing combinations of hard-wired circuitry and software instructions may be used to implement embodiments of the present invention. That is, embodiments of the present invention are not limited to any specific combination of hardware and software.

Embodiments of the present invention are applicable for use with different types of data networks and clusters designed to link together computers, servers, peripherals, storage devices, and/or communication devices for communications. Examples of such data networks may include a local area network (LAN), a wide area network (WAN), a campus area network (CAN), a metropolitan area network (MAN), a global area network (GAN), a storage area network and a system area network (SAN), including data networks using Next Generation I/O (NGIO), Future I/O (FIO), Infiniband and Server Net and those networks that may become available as computer technology develops in the future. LAN systems may include Ethernet, FDDI (Fibre Distributed Data Interface) Token Ring LAN, Asynchronous Transfer Mode (ATM) LAN, Fibre Channel, and Wireless LAN.

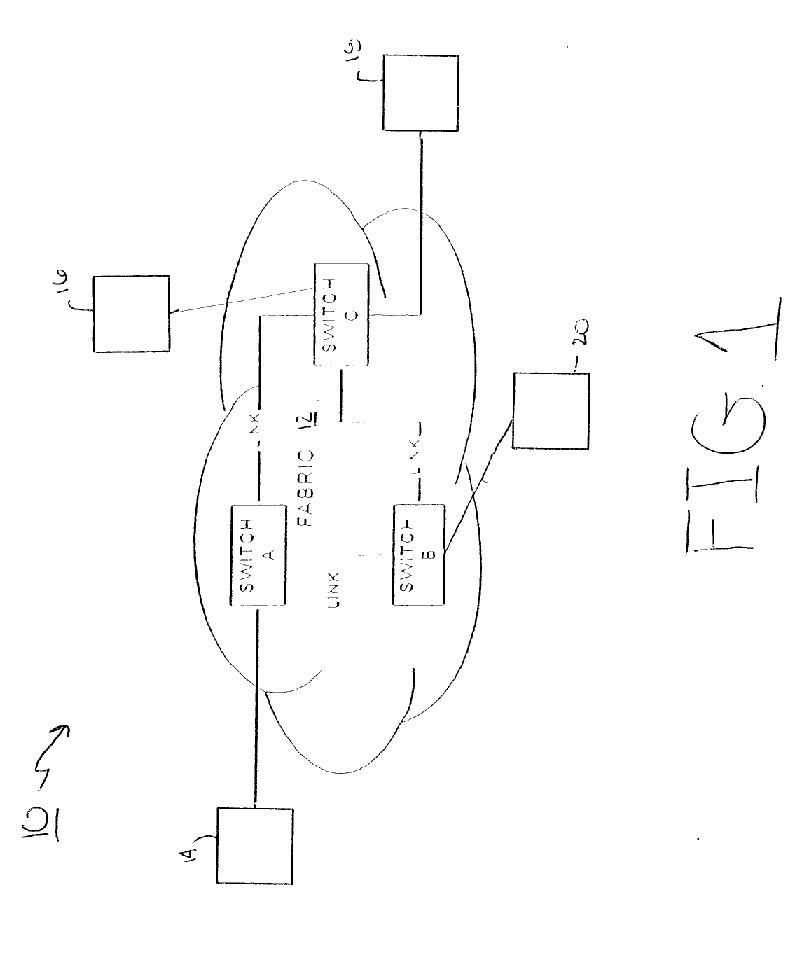

FIG. 1 shows an example data network 10 having several interconnected endpoints (nodes) for data communications according to one arrangement. Other arrangements are also possible. As shown in FIG. 1, the data network 10 may include an interconnection fabric (hereafter referred to as “switched fabric”) 12 of one or more switches (or routers) A, B and C and corresponding physical links, and several endpoints (nodes) that may correspond to one or more servers 14, 16, 18 and 20 (or server assemblies).

The servers may be organized into groups known as clusters. A cluster is a group of one or more hosts, I/O units (each I/O unit including one or more I/O controllers) and switches that are linked together by an interconnection fabric to operate as a single system to deliver high performance, low latency, and high reliability. The servers 14, 16, 18 and 20 may be interconnected via the switched fabric 12.

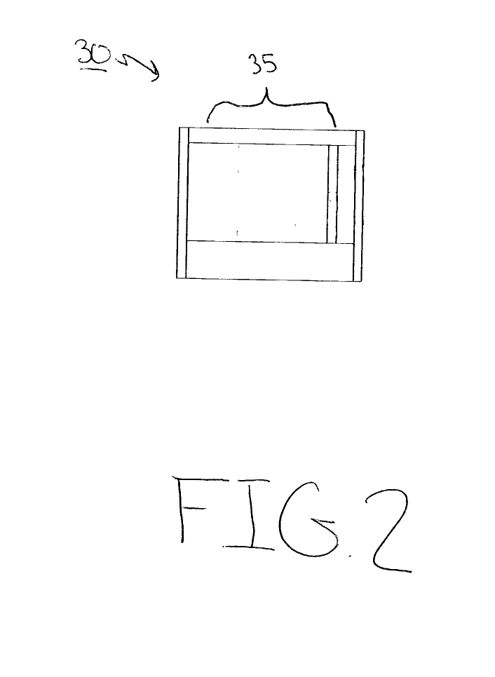

FIG. 2 is example server assembly according to one arrangement. Other arrangements are possible. More specifically, FIG. 2 shows a server assembly (or server housing) 30 having a plurality of server blades 35. The server assembly 30 may be a rack-mountable chassis and may accommodate a plurality of independent server blades 35. For example, the server assembly shown in FIG. 2 houses sixteen server blades. Other numbers of server blades are also possible. Although not specifically shown in FIG. 2, the server assembly 30 may include a built-in system cooling and temperature monitoring device(s). The server blades 35 may be hot-pluggable for all the plug-in components. Each of the server blades 35 may be a single board computer that, when paired with companion rear panel media blades, may form independent server systems. That is, each server blade may include a processor, RAM, an L2 cache, an integrated disk drive controller, and BIOS, for example. Various switches, indicators and connectors may also be provided on each server blade. Though not shown in FIG. 2, the server assembly 30 may include rear mounted media blades that are installed inline between server blades. Together, the server blades and the companion media blades may form independent server systems. Each media blade may contain hard disk drives. Power sequencing circuitry on the media blades may allow a gradual startup of the drives in a system to avoid power overload during system initialization. Other components and/or combinations may exist on the server blades or media blades and within the server assembly. For example, a hard drive may be on the server blade, multiple server blades may share a storage blade or the storage may be external.

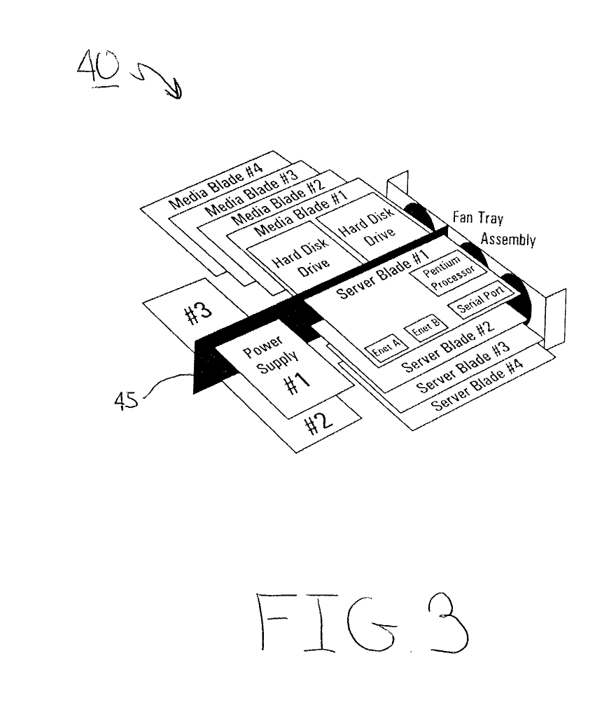

FIG. 3 shows a server assembly 40 according to one example arrangement. Other arrangements are also possible. More specifically, the server assembly 40 includes Server Blade #1, Server Blade #2, Sever Blade #3 and Server Blade #4 mounted on one side of a chassis 42, and Media Blade #1, Media Blade #2, Media Blade #3 and Media Blade #4 mounted on the opposite side of the chassis 42. The chassis 42 may also support Power Supplies #1, #2 and #3. Each server blade may include Ethernet ports, a processor and a serial port, for example. Each media blade may include two hard disk drives, for example. Other configurations for the server blades, media blades and server assemblies are also possible.

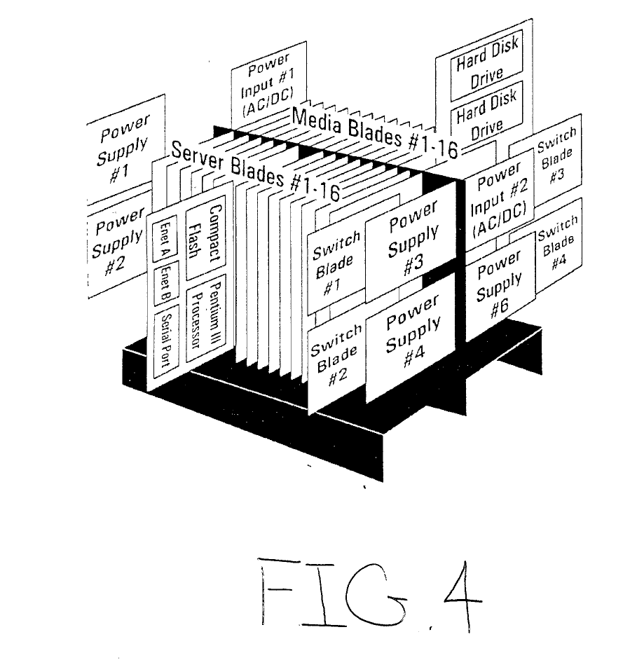

FIG. 4 shows a server assembly according to another example arrangement. Other arrangements are also possible. The server assembly shown in FIG. 4 includes sixteen server blades and sixteen media blades mounted on opposite sides of a chassis.

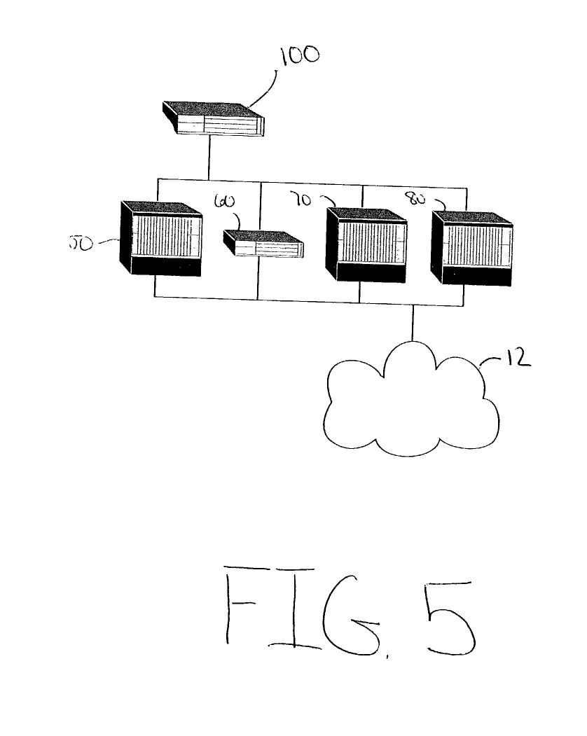

FIG. 5 shows a topology of distributed server assemblies according to an example embodiment of the present invention. Other embodiments and configurations are also within the scope of the present invention. More specifically, FIG. 5 shows the switched fabric 12 coupled to a server assembly 50, a server assembly 60, a server assembly 70 and a server assembly 80. Each of the server assemblies 50, 60, 70 and 80 may correspond to one of the server assemblies shown in FIGS. 3 and 4 or may correspond to a different type of server assembly. Each of the server assemblies 50, 60, 70 and 80 may also be coupled to a deployment server 100. The coupling to the deployment server 100 may or may not be through the switched fabric 12. That is, the deployment server 100 may be local or remote with respect to the server assemblies 50, 60, 70 and 80.

As shown in FIG. 6, the deployment server 100 may include an operating system 102 and application software 104 as will be described below. The deployment server 100 may also include a storage mechanism 106, and a processing device 108 to execute programs and perform functions. The storage mechanism 106 may include an image library to store images of various systems (or entities) such as operating systems of clusters. The deployment server 100 may manage distribution of software (or other types of information) to and from servers. That is, the deployment server 100 may distribute, configure and manage servers on the server assemblies 50, 60, 70 and 80, as well as other servers. The deployment server 100 may include a deployment manager application (or mechanism) and a dynamic cluster manager application (or mechanism) to distribute, configure and manage the servers.

The deployment server 100 may monitor various conditions of the servers associated with the deployment server 100. In accordance with embodiments of the present invention, the deployment server 100 may gather images from respective servers based on observed conditions and re-deploy servers by deploying (or copying) gathered images. The deployment server 100 may also notify the respective entities regarding shifted functions of the servers. The deployment server may shift the function of hardware on servers so as to reallocate the hardware to different tasks. That is, software may be deployed onto different hardware so that the redeployed server may perform a different function. Accordingly, the deployment server 100 may shift the function of hardware by copying software (or other types of information) and deploying the software to a different server. This may shift the hardware to a different type of cluster.

The deployment server 100 may contain rules (or thresholds) that allow a server blade to be deployed with an image from another server blade based upon health/performance information. This may occur, for example, if the average processor utilization is over a predetermined value for a certain amount of time or if something fails.

Embodiments of the present invention may provide a first mechanism within a deployment server to determine a status of a first hardware entity (such as a first server). A second mechanism within a deployment server may gather an image of a second hardware entity. The gathered image may relate to software (or other information) on the first hardware entity. The status may relate to utilization of a processor on the first hardware entity or temperature of the first hardware entity, for example. A third mechanism within the deployment server may deploy the image of the second hardware entity to the first hardware entity based on the determined status.

A dynamic deployment mechanism may be provided on the deployment server 100 based on a deployment manager application and clustering software (or load balancing software). The dynamic deployment mechanism may be a software component that runs on the deployment server 100 and that would be in contact with existing cluster members. The cluster members may include web clusters and mail clusters, for examples. Other types of clusters are also within the scope of the present invention. The cluster members may provide information back to the deployment server 100. This information may include processor utilization, temperature of the board, hard drive utilization and memory utilization. Other types of information are also within the scope of the present invention. The monitoring of the servers (or clusters) and notification back to the deployment server 100 may be automatically performed by the deployment server 100. The dynamic cluster manager application (or mechanism) may monitor these values, and then based upon predetermined rules (or thresholds), the deployment server 100 may deploy new members to a cluster when additional capacity is needed. The deployment server 100 may also reclaim resources from clusters that are not being heavily used. Resources may be obtained by utilizing an interface to a disk-imaging system that operates to gather and deploy an image. The dynamic cluster manager application (or mechanism) may maintain information about the resources available, the resources consumed, the interdependencies between resources, and the different services being run on the resources. Based on the data and predetermined rules, the deployment server 100 may decide whether clusters need additional resources. The deployment server 100 may utilize the disk-imaging tool and deploy a disk image to that resource. Embodiments of the present invention are not limited to disk images, but rather may include flash images as well as random-access memory (RAM), field-programmable gate array (FPGA) code, microcontroller firmware, routing tables, software applications, configuration data, etc. After imaging, the deployment manager application (or mechanism) may forward configuration commands to the new resource that would execute a program to allow that resource to join a cluster. In order to downsize a cluster, resources may be redeployed to another cluster that needs extra resources. As an alternative, the resources may be shut down.

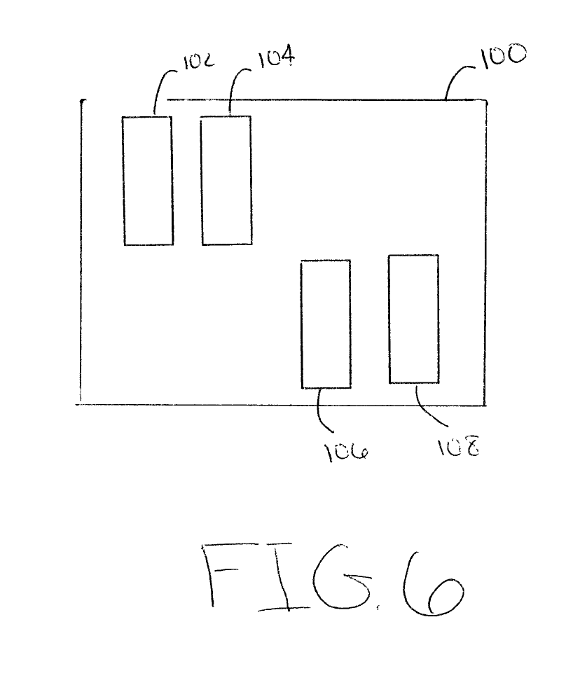

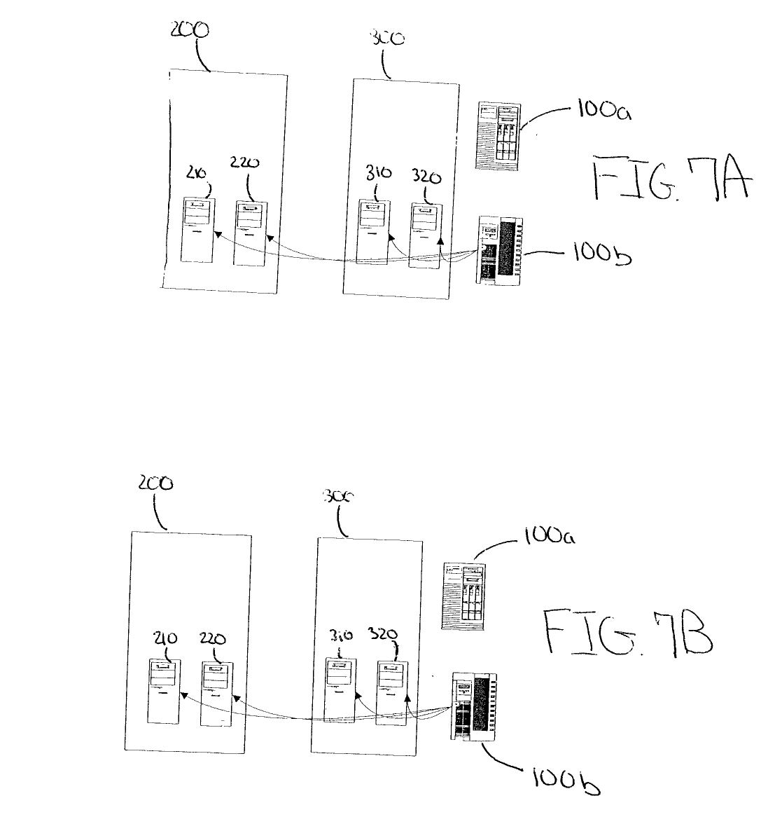

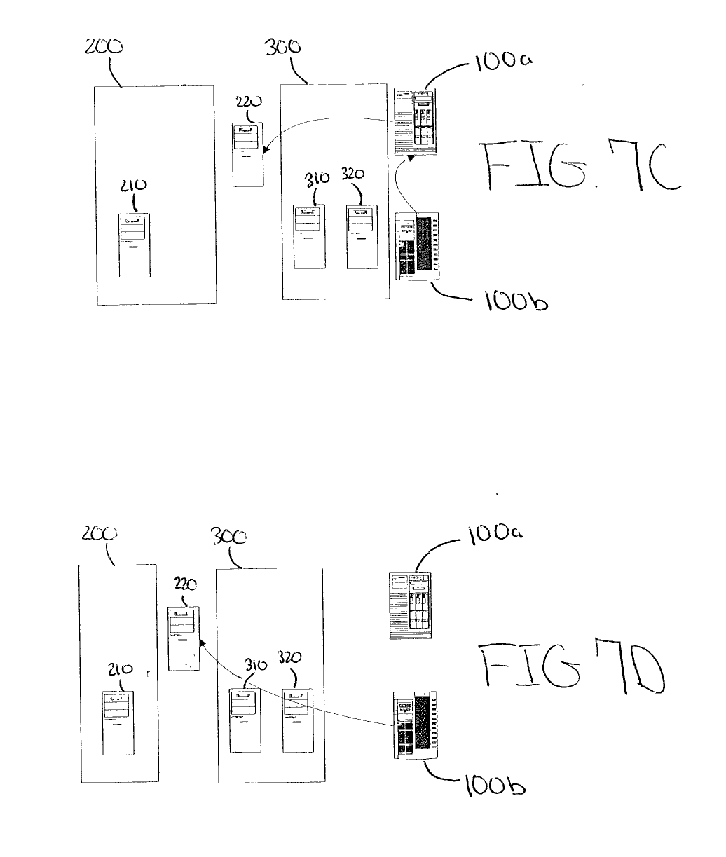

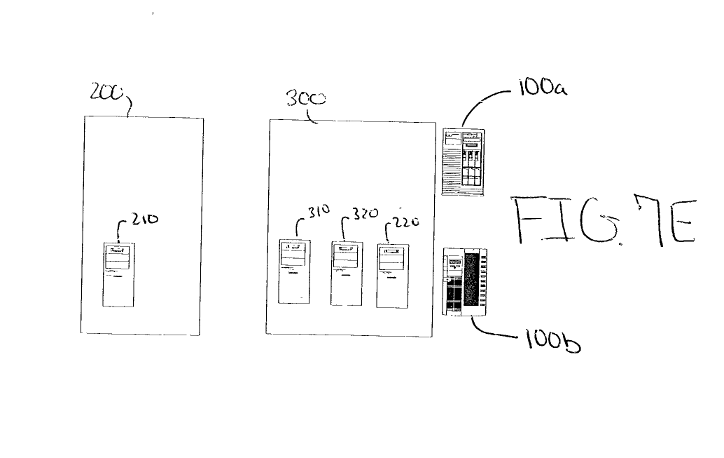

FIGS. 7A-7E show a dynamic deployment mechanism according to an example embodiment of the present invention. Other embodiments and methods of redeployment are also within the scope of the present invention. More specifically, FIGS. 7A-7E show utilization of a plurality of servers based on the deployment server 100. Other deployment servers may also be used. For ease of illustration, the servers shown in FIGS. 7A-7E are grouped into clusters such as a mail cluster 200 and a web cluster 300. Other clusters are also within the scope of the present invention. One skilled in the art would understand that clusters do not relate to physical boundaries of the network but rather may relate to a virtual entity formed by a plurality of servers or other entities. Clusters may contain servers that are spread out over a geographical area.

The deployment server 100 may include software entities such as a deployment mechanism 100A and a dynamic cluster mechanism 100B. The deployment mechanism 100A may correspond to the deployment manager application discussed above and the dynamic cluster mechanism 100B may correspond to the dynamic cluster manager application discussed above.

FIG. 7A shows a topology in which the mail cluster 200 includes a server 210 and a server 220, and the web cluster 300 includes a server 310 and a server 320. Each cluster includes hardware entities (such as servers or server assemblies) that perform similar functions. That is, the servers 210 and 220 may perform services (or functions) relating to email, whereas the servers 310 and 320 may perform services (or functions) relating to web pages. As shown in FIG. 7A, the dynamic cluster mechanism 100B may automatically poll each of the servers 210, 220, 310 and 320 for load or status information as discussed above. The polling may occur on a periodic basis and may be automatically performed by the dynamic cluster mechanism 100B. Information may be sent back to the deployment server 100 based on this polling. Embodiments of the present invention are not limited to information being sent based on polling. For example, one of the servers may generate an alert that there is a problem.

In FIG. 7B, the dynamic cluster mechanism 100B may determine that the servers 310 and 320 are both above 90% of the processor utilization and that the servers 210 and 220 are both below 20% of the processor utilization. In other words, the dynamic cluster mechanism 100B may determine that the servers 310 and 320 are being heavily used (according to a predetermined threshold) and the servers 210 and 220 are being under used (according to a predetermined threshold). Based on this determination, the dynamic cluster mechanism 100B may send an instruction to the server 220 in the mail cluster 200, for example, to remove itself from the mail cluster 200. Stated differently, the dynamic cluster mechanism 100B may decide to shift a function of the server 220.

The need for more resources (or a failure) may be based on other factors such as testing response time and whether it can perform the test task in a certain amount of time with the appropriate return (e.g. serving up a web page properly). Further, the threshold need not be predetermined. If a server cluster has spare resources and some of the servers are at 80% then a server may be added to the cluster even if the threshold is 90%. More than one threshold may also be utilized.

In FIG. 7C, the dynamic cluster mechanism 100B instructs the deployment mechanism 100A to re-deploy spare resources of the server 220 to the same configuration as one of the servers 310 and 320 within the web cluster 300. The deployment mechanism 100A may deploy an image of the web server application onto the server 220 since the deployment mechanism 100A has the image of the web cluster 300 (such as in an image library).

In FIG. 7D, the dynamic cluster mechanism 100B may send cluster information to the server 220. Finally, in FIG. 7E, the server 220 may start to function as a member of the web cluster 300.

Accordingly, as described above, the deployment server 100 may utilize software to capture an image on a respective server. The captured image may correspond to a file within a hard drive that is wrapped up into a single file. The deployment server 100 may perform these operations automatically. That is, the deployment server 100 may automatically gather and deploy images.

Clustering software and load balancers may also be utilized to notify proper entities of the redeployment of the servers. The deployment server 100 may split loads between different servers or distribute the server usage. The servers may then be tied together by configuring them as a cluster. This shifts the function of the hardware entity so as to reallocate different tasks. That is, hardware functions may be changed by utilizing the software of the deployment server.

While embodiments of the present invention have been described with respect to servers or server blades, embodiments are also applicable to other hardware entities that contain software or to programmable hardware, firmware, etc.

In accordance with embodiments of the present invention, the deployment server may also monitor disk free space, memory utilization, memory errors, hard disk errors, network throughput, network ping time, service time, software status, voltages, etc.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Further, embodiments of the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), semiconductor memory devices such as EPROMs, EEPROMs and flash devices, etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. An entity comprising:
a first mechanism to determine a status of a first hardware entity;
a second mechanism to gather an image of a second hardware entity; and
a third mechanism to deploy said image of said second hardware entity to said first hardware entity based on said determined status.

2. The entity of claim 1, wherein said second hardware entity performs a different function than said first hardware entity.

3. The entity of claim 1, wherein said status relates to utilization of a processor on said first hardware entity.

4. The entity of claim 1, wherein said status relates to one of temperature and utilization of said first hardware entity.

5. The entity of claim 1, wherein said entity comprises a deployment server located remotely from said first hardware entity.

6. The entity of claim 1, wherein said first, second and third mechanisms occur automatically.

7. A mechanism to monitor a first hardware entity and to shift information from a second hardware entity to said first hardware entity.

8. The mechanism of claim 7, wherein said first hardware entity comprises a first blade and said second hardware entity comprises a second blade.

9. The mechanism of claim 7, wherein said first blade comprises a server.

10. The mechanism of claim 7, wherein said second hardware entity performs a different function than said first hardware entity.

11. The mechanism of claim 7, wherein said mechanism monitors a status of said first hardware entity and shifts software based on said status.

12. The mechanism of claim 11, wherein said status relates to utilization of a processor on said first hardware entity.

13. The mechanism of claim 11, wherein said status relates to one of temperature and utilization of said first hardware entity.

14. The mechanism of claim 7, wherein said mechanism is provided within a deployment server located remotely from said first hardware entity.

15. The mechanism of claim 7, wherein said shift of software occurs by gathering an image from said second hardware entity and deploying said image to said first hardware entity.

16. A server comprising a mechanism to monitor a first entity remotely located from said server, and to automatically shift a function of said first entity based on a monitored status.

17. The server of claim 16, wherein said function of said first entity is shifted by moving said first entity into a different cluster.

18. The server of claim 16, wherein said function of said first entity is shifted by gathering an image from a second entity and deploying said image onto said first entity.

19. A method comprising:
determining a status of a first hardware entity;
gathering an image of a second hardware entity; and
deploying said image of said second hardware entity to said first hardware entity based on said determined status.

20. The method of claim 19, wherein said second hardware entity performs a different function than said first hardware entity.

21. The method of claim 19, wherein said status relates to utilization of a processor on said first hardware entity.

22. The method of claim 19, wherein said status relates to one of temperature and utilization of said first hardware entity.

23. The method of claim 19, wherein said mechanism is provided within a deployment server located remotely from said first hardware entity.

24. A program storage device readable by machine, tangibly embodying a program of instructions executable by the machine to perform a method comprising:
determining a status of a first hardware entity;
gathering an image of a second hardware entity; and
deploying said image of said second hardware entity to said first hardware entity based on said determined status.

25. The program storage device of claim 24, wherein said second hardware entity performs a different function than said first hardware entity.

26. The program storage device of claim 24, wherein said status relates to utilization of a processor on said first hardware entity.

27. The program storage device of claim 24, wherein said status relates to one of temperature and utilization of said first hardware entity.

28. The program storage device of claim 24, wherein said mechanism is provided within a deployment server located remotely from said first hardware entity.

29. A network comprising:
a first entity;
a second entity; and
a deployment entity to determine a status of said first entity, to gather an image of said second entity, and to deploy said image of said second entity to said first entity.

30. The network of claim 29, wherein said deployment of said image is based on said determined status.

31. The network of claim 29, wherein said first entity and said second entity each comprise a server.
